(19) United States
(12) Patent Application Publication
(10) Pub. No.: US 2008/0166647 A1
(43) Pub. Date: Jul. 10, 2008

(54) TONER INCLUDING CRYSTALLINE POLYESTER AND WAX

(75) Inventors: Mark E. MANG, Rochester, NY (US); Gerald P. COX, Brockport, NY (US); Louis J. KURTIC, Fairport, NY (US); Matthew L. FABRIZIO, Rochester, NY (US); Robert S. PAWLIK, Webster, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/627,212

(22) Filed: Jan. 25, 2007

Related U.S. Application Data
(60) Provisional application No. 60/863,657, filed on Oct. 31, 2006.

(51) Int. Cl. G03G 9/00

(52) U.S. Cl. 430/108.4

(57) ABSTRACT

A toner disclosed that includes a binder, at least one colorant and at least one wax, wherein the binder includes an amorphous polyester material, a crosslinked polyester material, a crystalline polyester material, and wherein the toner has a glass transition temperature of from about 35° C. to about 60° C.

### BACKGROUND

Described herein are toners comprising binder, at least one colorant and at least one wax, wherein the binder comprises at least an amorphous polyester material and a crystalline polyester material. Methods of forming such toner and developers containing such toner are also described.

Toners comprised of binder resins that include a linear portion as well as a portion of crosslinked microgel particles are known. U.S. Pat. Nos. 5,227,460, 5,352,556, 5,376,494, 5,395,723 and 5,401,602, each incorporated herein by reference in its entirety, describe a low melt toner resin with low minimum fix temperature and wide fusing latitude that contains a linear portion and a crosslinked portion of high density crosslinked microgel particles, but substantially no low density crosslinked polymer. It is described that the resin may be formed by reactive melt mixing under high shear and high temperature of an unsaturated polyester resin such as a propoxylated bisphenol A fumarate in the presence of a chemical initiator mixed into the polyester.

U.S. Pat. No. 6,890,695 describes a toner for electrophotography comprising a resin binder comprising a crystalline polyester and an amorphous resin, wherein the crystalline polyester is dispersed in the resin binder in an amount of from 1 to 40% by weight, and wherein 90% or more of a dispersed domain of the crystalline polyester has a diameter of from 0.1 to 2 μm.

U.S. Publication No. 2006/0115758, incorporated herein by reference in its entirety, describes a toner that includes a binder and at least one colorant, wherein the binder includes an amorphous polyester material, a crosslinked polyester material, an optional embrittling agent material, and a crystalline polyester material.

Toners such as discussed above are adequate in various performance properties, and are thus suitable for their intended purpose. In fact, materials of the above-discussed toners may be suitably used in embodiments described herein with respect to the present toner. However, such toners may still be further improved. For example, these toners may be improved in properties including crease area, fusing temperature and edge waviness.

### SUMMARY

It is thus an object herein to develop a toner composition with excellent performance, including in crease area, fusing temperature and/or edge waviness.

These and other objects are achieved by the various embodiments described herein. In embodiments, described is an emulsion aggregation toner comprising binder, at least one colorant and at least one wax, wherein the binder comprises at least an amorphous polyester material and a crystalline polyester material. In embodiments, described is a method of making a toner, comprising forming an emulsion containing at least a binder, at least one colorant and at least one wax, wherein the binder comprises an amorphous polyester material and a crystalline polyester material, forming particle aggregates by subjecting the emulsion to aggregation conditions, and optionally coalescing the particle aggregates.

In embodiments, described is a toner comprising a binder, at least one colorant and at least one wax, wherein the binder comprises an amorphous polyester material, a crosslinked polyester material, a crystalline polyester material, and wherein the toner has a glass transition temperature of from about 35° C. to about 60° C.

In further embodiments, described is a developer comprising:

a toner comprising a binder, at least one colorant and at least one wax, wherein the binder comprises an amorphous polyester material, a crosslinked polyester material, a crystalline polyester material, and

a carrier.

### BRIEF DESCRIPTION OF THE DRAWINGS

FIG. 1 is a plot of crease area (y-axis) and fusing temperature (x-axis).

FIG. 2 is a plot of edge waviness (y-axis) and fusing temperature (x-axis).

FIG. 3 is a visual rating reference for edge waviness performance.

FIG. 4 is a crease scale rating reference.

### EMBODIMENTS

In embodiments, a toner is achieved that comprises a binder, at least one colorant and at least one wax, wherein the binder comprises an amorphous polyester material and a crystalline polyester material. The binder may also desirably include an additional crosslinked polyester material.

The amorphous polyester material and crosslinked polyester material of the binder will first be described. The amorphous polyester material of the binder may be a linear material, although branched amorphous polyester may be used in place of or in combination with a linear amorphous polyester. The crosslinked polyester material may be comprised of high-density crosslinked microgel particles. Although low-density crosslinked material may be present, desirably the crosslinked polyester material contains substantially no low-density crosslinked polymer.

The inclusion of crosslinked portions in the polyester is desired as highly crosslinked dense microgel particles impart elasticity to the binder, which improves the toner offset properties while not substantially affecting the resin minimum fix temperature (MFT). With a higher degree of crosslinking or microgel content, the hot offset temperature (HOT) increases. The maximum temperature at which the toner does not adhere to the fusser roll is called the hot offset temperature (HOT). When the fusser temperature exceeds HOT, some of the molten toner adheres to the fuser roll during fixing and is transferred to subsequent substrates containing developed images, resulting for example in blurred images. This undesirable phenomenon is called offsetting. Less than the HOT of the toner is the minimum fix temperature (MFT) of the toner, which is the minimum temperature at which acceptable adhesion of the toner to the support medium occurs, that is, as determined by, for example, a crease test. The difference between MFT and HOT is called the fusing latitude of the toner. Also as the degree of crosslinking or microgel content increases, the low temperature melt viscosity does not change appreciably, while the high temperature melt viscosity goes up.

Illustrative examples of suitable materials selected for the amorphous polyester material include polyesters such as the polymeric esterification products of a dicarboxylic acid and a diol comprising a diphenol. The esterification product of an aliphatic alcohol and an isophthalic acid may be used. The amorphous polyester may be a homopolymer or copolymer of two or more monomers. As one resin, there are selected polyester resins derived from a dicarboxylic acid and a diphenol. These resins are illustrated in, for example, U.S. Pat. No. 3,590,000, the disclosure of which is totally incorporated herein by reference. Suitable amorphous polyester materials that are commercially available include GTUF and FPESL-2 from Kao Corporation, Japan, and EM181635 from Reichhold, Research Triangle Park, N.C.

In embodiments, the amorphous polyester may be obtained from the reaction of bisphenol A and propylene oxide or propylene carbonate, and in particular including such polyesters followed by the reaction of the resulting product with fumaric acid (reference U.S. Pat. No. 5,227,460, the disclosure of which is totally incorporated herein by reference). For example, the amorphous polyester resin comprises a polypropoxylated bisphenol A fumarate polyester. An example linear propoxylated bisphenol A fumarate resin is available under the trade name SPARII from Resana S/A Industrias Quimicas, Sao Paulo Brazil.

The toner binder may include the amorphous polyester in an amount from, for example, about 25% to about 85% by weight, such as from about 25% to about 75% or from about 40% to about 75% by weight, of the binder.

In embodiments, the amorphous polyester material and crosslinKed polyester material are comprised of the same polyester. For example, the amorphous polyester material is a linear polyrpropoxylated bisphenol A fumarate polyester while the crosslinked polyester material is comprised of crosslinked polypropoxylated bisphenol A fumarate polyester. In the embodiment in which the amorphous and crosslinked polyester materials are comprised of the same polyester, the crosslinked material may be comprised of crosslinked portions of the amorphous polyester. Thus, the amorphous and crosslinked polyester may be comprised of a resin containing both linear portions and crosslinked portions, for example of the type described in U.S. Pat. No. 5,227,460, discussed immediately above. These resins may be prepared by, for example, reactive extrusion as described in U.S. Pat. No. 5,227,460 or liquid reactive extrusion as described in U.S. Pat. No. 6,359,105. The crosslinked portion of the binder may consist essentially of microgel particles with an average volume particle diameter of about 0.005 to about 0.1 micron, as determined by scanning electron microscopy and transmission electron microscopy, the microgel particles being substantially uniformly distributed throughout the amorphous linear portions. The crosslinked portions are preferably highly crosslinked gel particles that are not soluble in substantially any solvent such as tetrahydrofuran, toluene and the like, and are called gel. As detailed in U.S. Pat. No. 5,227,460, the binder resin is preferably substantially free of crosslinked portions that are low in crosslinking density (which low crosslinking density materials are soluble in some solvents such as tetrahydrofuran, toluene and the like), called sol.

The amorphous and crosslinked polyester materials of the binder are thus, in one embodiment of the invention, comprised of a partially crosslinked unsaturated polyester resin. Such resin may be prepared as detailed in U.S. Pat. No. 5,227,460. The partially crosslinked polyester resin may be comprised of an unsaturated polyester prepared by crosslinking a linear unsaturated polyester base resin (hereinafter called base resin), preferably with a chemical initiator, in a melt mixing device such as, for example, an extruder at high temperature (for example, above the melting temperature of the resin and preferably up to about 150° C. above the glass transition temperature (Tg) of the resin) and under high shear.

The amorphous, desirably linear, portion of the resin may comprise low molecular weight reactive base resin of the same polyester used for forming the crosslinked portions. The molecular weight distribution of the polyester resin is thus bimodal, having different ranges for the amorphous portion and the crosslinked portion of the binder. The weight average molecular weight (Mw) of the amorphous portion may be in the range of from, for example, about 8,000 to about 40,000. The weight average molecular weight of the gel portions is, on the other hand, not generally measurable by standard analytical techniques due to the insolubility of this portion of the resin; however, it is believed to be greater than at least 300,000.

In embodiments, the amorphous and crosslinked materials may be formed separately and mixed together in forming the binder resin. For example, the binder containing both of these materials may be made by mixing the amorphous polyester resin with the appropriate amount of separately formed crosslinked polyester material, which may or may not be comprised of the same polyester as the amorphous polyester material.

If separately formed, the crosslinked polyester may comprise very high molecular weight microgel particles with high density crosslinking (as measured by gel content) and which are not soluble in substantially any solvents such as, for example, tetrahydrofuran, toluene and the like. The microgel particles are highly crosslinked polymers. This type of crosslinked polyester may be formed through crosslinking of a linear unsaturated polyester with the use of a suitable chemical initiator, for example at high temperature and under high shear. The initiator molecule may break into radicals and reacts with one or more double bonds or other reactive sites within the polymer chain, forming a polymer radical. This polymer radical reacts with other polymer chains or polymer radicals many times, forming a highly crosslinked microgel. This renders the microgel very dense and results in the microgel not swelling very well in solvent. The dense microgel also imparts elasticity to the resin and increases its hot offset temperature while not affecting its minimum fix temperature.

The crosslinked polyester material may be a crosslinked polyester of any of the polyester materials discussed above with respect to the amorphous polyester material. Again, the crosslinked polyester material incorporated into the binder may be the same or different from the amorphous polyester material. The crosslinked polyester may comprise a crosslinked propoxylated bisphenol A fumarate resin.

The toner binder may contain the crosslinked polyester in an amount such that the gel content of the binder is from, for example, about 1% to about 50% by weight, such as from about 3% to about 50% by weight or from about 5% to about 30% by weight, of the binder.

In addition to the amorphous polyester and optional crosslinked polyester, the binder of the toner particles also includes a crystalline polyester material. By crystalline is meant that the polyester has some degree of crystallinity, and thus crystalline is intended to encompass both semicrystalline and frilly crystalline polyester materials. The polyester is considered crystalline when it is comprised of crystals with a regular arrangement of its atoms in a space lattice. An amorphous polyester, on the other hand, lacks such an organized crystalline structure and lacks a defined melting point.

The crystalline polyester may be a crystalline polyester resin such as detailed in U.S. Pat. Nos. 6,653,435 and 6,780,557, each incorporated herein by reference in its entirety. For example, the crystalline polyester may be obtained by polycondensing an alcohol component comprising 80% by mole or more of an aliphatic diol having 2 to 6 carbon atoms, such as 4 to 6 carbon atoms, with a carboxylic acid component comprising 80% by mole or more of an aliphatic dicarboxylic acid compound having 2 to 8 carbon atoms, such as 4 to 6 carbon atoms or 4 carbon atoms. See, for example, U.S. Pat. No. 6,780,557. The aliphatic diol having 2 to 6 carbon atoms may include ethylene glycol, 1,2-propylene glycol, 1,3-propylene glycol, 1,4-butanediol, 1,5-pentanediol, 1,6-hexanediol, neopentyl glycol, 1,4-butanediol, and the like. It is desirable that the aliphatic diol is contained in the alcohol component in an amount of about 80% by mole or more, such as from about 85 to 100% by mole. The alcohol component may also contain a polyhydric alcohol component other than the aliphatic diol having 2 to 6 carbon atoms. Such a polyhydric alcohol component includes a divalent aromatic alcohol such as an alkylene (2 to 3 carbon atoms) oxide adduct (average number of moles added being 1 to 10) of bisphenol A, such as polyoxypropylene (2.2)-2,2-bis (4-hydroxyphenyl) propane and polyoxyethylene (2.2)-2,2-bis(4-hydroxyphenyl) propane; a trihydric or higher polyhydric alcohol component such as glycerol, pentaerythritol and trimethylolpropane; and the like. The aliphatic dicarboxylic acid compound having 2 to 8 carbon atoms includes oxalic acid, malonic acid, maleic acid, fumaric acid, citraconic acid, itaconic acid, glutaconic acid, succinic acid, adipic acid, acid anhydrides thereof alkyl (1 to 3 carbon atoms) esters thereof, and the like. It is desirable that the aliphatic dicarboxylic acid compound is contained in the carboxylic acid component in an amount of about 80% by mole or more, such as from about 85 to 100% by mole. Among them, from the viewpoint of the storage ability of the crystalline polyester, it is desirable that fumaric acid is contained in the carboxylic acid component in an amount of about 60% by mole or more, such as about 70 to 100% by mole. The carboxylic acid component may contain a polycarboxylic acid component other than the aliphatic dicarboxylic acid compound having 2 to 8 carbon atoms. Such a polycarboxylic acid component includes aromatic dicarboxylic acids such as phthalic acid, isophthalic acid and terephthalic acid; aliphatic dicarboxylic acids such as sebacic acid, azelaic acid, n-dodecylsuccinic acid and n-dodecenylsuccinic acid; alicyclic carboxylic acids such as cyclohexanedicarboxylic acid; tricarboxylic or higher polycarboxylic acids such as 1,2,4-benzenetricarboxylic acid (trimellitic acid) and pyromellitic acid; acid anhydrides thereof, alkyl (1 to 3 carbon atoms) esters thereof, and the like.

The crystalline polyester may also be derived from monomers containing an alcohol component comprising a trihydric or higher polyhydric alcohol, and a carboxylic acid component comprising a tricarboxylic or higher polycarboxylic acid compound as detailed in U.S. Pat. No. 6,653,435, incorporated herein by reference in its entirety. The trihydric or higher polyhydric alcohols include sorbitol, 1,2,3,6-hexanetetrol, 1,4-sorbitan, pentaerythritol, dipentaaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, and the like. Examples of the tricarboxylic or higher polycarboxylic acid compound include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol timer acid, acid anhydrides thereof, alkyl (1 to 3 carbon atoms) esters thereof, and the like.

The aforementioned crystalline polyester materials may be prepared by the polycondensation reactions described in the aforementioned patents.

In embodiments, the crystalline polyester material may be derived from a monomer system comprised of an alcohol selected from among 1,4-butanediol, 1,6-hexanediol, and mixtures thereof with a dicarboxylic acid selected from among fumaric acid, succinic acid, oxalic acid, adipic acid, and mixtures thereof. For example, the crystalline polyester may be derived from 1,4-butanediol and fumaric acid, the polyester having a crystallinity of about 25 to about 75%, more preferably about 40 to about 60%.

The crystalline polyester may have a melting point of from about 85° C. to about 150° C., such as from about 90° C. to about 140° C.

In embodiments, the crystalline polymer may desirably be included in the binder in an amount of from about 3% to about 60% by weight, for example from about 5% to about 50% by weight or from about 10% to about 40% by weight of the toner.

The toner also includes at least one wax. The wax may function as, for example, a release agent to assist in the release of toner images from a fuser roll. Examples of waxes are known, and include, for example, alkylenes, such as polypropylene, polyethylene, and the like. The waxes may be hydrophobic and essentially water insoluble. The wax may include (1) natural waxes such as those extracted from vegetables (carnauba wax, Japan wax, bayberry wax) or animals (beeswax, shellac wax, spermaceti wax); (2) mineral waxes, such as those extracted, for example, from bituminous lignite or share (montan wax, ozokerite wax, ceresin wax); (3) petroleum waxes, complex mixtures of paraffinic hydrocarbons obtained from the distillation of ciride petroleum (paraffin wax), or by dewaxing heavy lubricating oils and petrolatum residues (microcrystalline wax); and (4) synthetic waxes generated, for example, by chemical processes including petroleum, Fischer-Tropsch (by coal gasification), polyethylene, polypropylene, acrylate, fatty acid amides, silicone and polytetrafluoroethylene waxes. Specific examples of waxes for use herein include polypropylenes and polyethylenes such as commercially available from Allied Chemical and Petrolite Corporation (for example, the POLYWAX™ line of waxes), wax emulsions available from Michaelman, Inc. and the Daniels Products Company, EPOLENE N-15™ commercially available from Eastman Chemical Products, Inc., VISCOL 550-P™, a low weight average molecular weight polypropylene available from Sanyo Kasei K. K., and similar materials. Additional examples of suitable waxes include natural waxes such as carnauba wax, functionalized waxes such as amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro is Powder Inc., imides, esters, quaternary amines, carboxylic acids or acrylic polymer emulsion, for example JONCRYL™ waxes, all available from SC Johnson Wax, chlorinated polypropylenes and polyethylenes available from Allied Chemical and Petrolite Corporation and SC Johnson Wax, and the like. Mixtures of waxes may also be used.

The toners may contain from, for example, about 2% to about 25% by weight of the toner, on a dry basis, of the wax. For example, the toners may contain wax in an amount of from about 2% to about 18% by weight or from about 8% to about 13% by weight of the toner.

A toner containing a combination of each of an amorphous polyester, desirably also with a crosslinked polyester, a crystalline polyester and a wax has several advantageous properties.

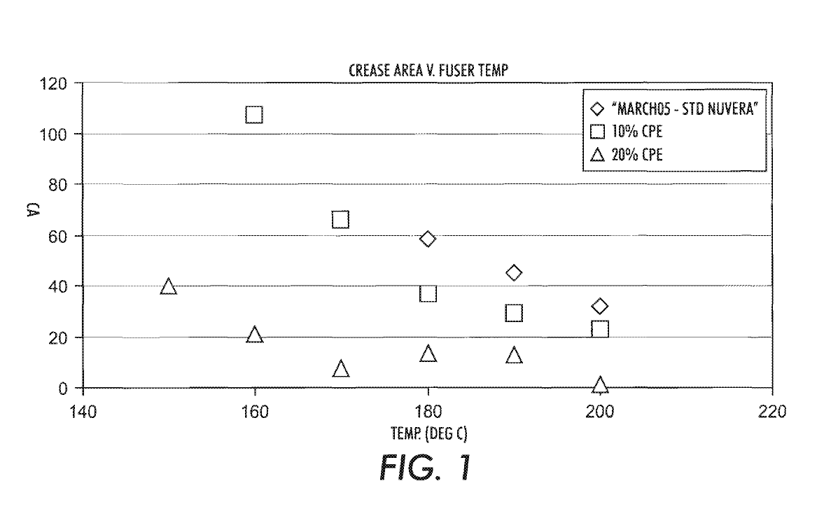

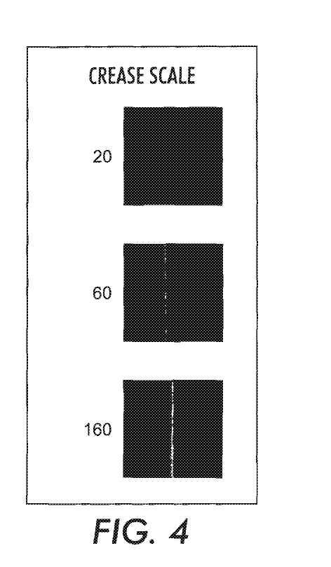

For example, as shown in FIG. 1, addition of 10% by weight crystalline polyester and 20% by weight crystalline polyester to a toner comprised of an amorphous polyester, in this case a propoxylated bisphenol A fumarate with partial crosslinking, and a wax results in a lowering of the fusing fixing temperature for a same crease area metric value. For crease area, a value below 60 is acceptable. Crease area, a measure of the degree of permanence of a fused image formed from the toner, may be evaluated by the crease area test in which a fused image is folded under a specific weight (typically a 0.68 kg roller) with the toner image to the inside of the fold. The image is then unfolded, and the crease is wiped with a clean pad using steady pressure, to determine the extent of toner removal in the crease area. Then, three 2.5 cm portions, including the center of the crease and on each side of the center of the crease, are evaluated for toner image separation from the substrate, and a value is assigned, taking into account the amount of paper showing through the crease, the width of the crease, and the existence of fracturing/cracking in the crease. FIG. 4 illustrates example crease values. A value of 160 represents nearly complete failure in the crease, whereas a value of 20 represents little damage in the crease area except in the area of the immediate crease. Thus, the greater the separation and/or the greater the extent of fractures/cracking through the toner image, the greater the crease area. A desired crease area is 60 or less.

As shown in FIG. 1, the crease area value of 60 or less can be obtained at much lower fuser fixing temperatures, thereby indicating that the combination of materials in the toner enables formation of a more robust and permanent image, less susceptible to damage, at a lower fusing temperature. Inclusion of the crystalline polyester material thus lowers the minimum fixing temperature of the toner.

Toners herein may thus have a minimum fixing temperature of from about 60° C. to about 200° C., such as from about 80° C. to about 160° C. or from about 80° C. to about 140° C. The toners also have a wide fusing latitude. The toners may have a fusing latitude greater than 10° C., such as from about 10° C. to about 120° C. or from about 20° C. to about 100° C.

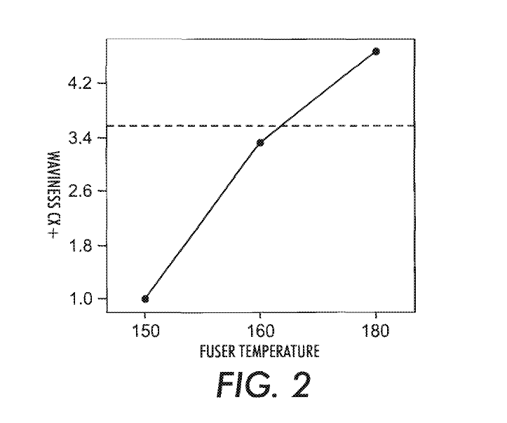

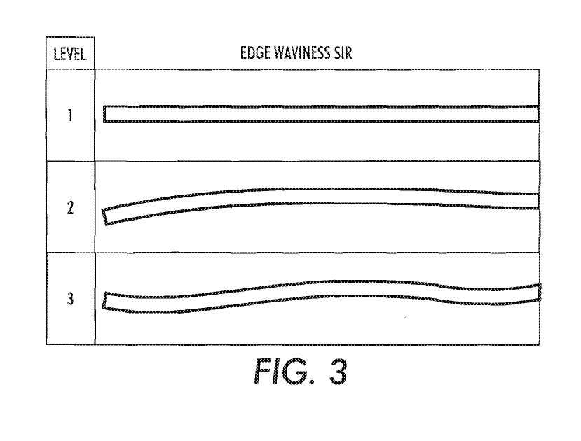

Another advantageous property associated with the toners herein is an ability to obtain an image on a paper substrate at lower fuser fixing temperatures with less of a tendency to cause unacceptable edge waviness in the paper. As shown in FIG. 3, edge waviness can be rated on a scale of 1 to 5, with 1 being the best and 5 the worst. Edge waviness may be determined by printing a test pattern comprised of a 5 cm solid area toner band and line prints onto a paper substrate such as XEROX COLOR EXPRESSIONS™+(CX+24 lb) or 4200 paper (20 lb). 10 sheets of paper having the test pattern printed thereon are stacked and placed on a flat surface, and the edge waviness is evaluated according to the scale illustrated in FIG. 3. An edge waviness value of 3 or less is desirable. Toners herein are able to achieve the edge waviness shown in FIG. 2, when printed upon XEROX COLOR EXPRESSIONS™+paper. As shown there, the edge waviness is acceptable, even at low fuser fixing temperatures. That is, the toner herein forms a toned image on paper exhibiting an edge waviness of 3 or less at fusing temperatures of about 160° C. or less.

The toners herein desirably exhibit a low glass transition temperature (Tg). For example, the toners may have a Tg of from about 35° C. to about 60° C., or from about 35° C. to about 58° C.

The toners herein desirably also include at least one colorant. The colorant may include pigment, dye, mixtures of pigment and dye, mixtures of pigments, mixtures of dyes, and the like. The colorant may be, for example carbon black, cyan, yellow, magenta, red, orange, brown, green, blue, violet or mixtures thereof.

Example pigments may include, for example, Violet PALIOGEN Violet 5100 (BASF); PALIOGEN Violet 5890 (BASF); HELIOGEN Green L8730 (BASF); LITHOL Scarlet D3700 (BASF); SUNFAST® Blue 15:4 (Sun Chemical 249-0592); Hostaperm Blue B2G-D (Clariant); Permanent Red P-F7RK; HOSTAPERM Violet BL (Clariant); LITHOL Scarlet 4440 (BASF); Bon Red C (Dominion Color Company); ORACET Pink RF (Ciba); PALIOGEN Red 3871 K (BASF); SUNFAST® Blue 15:3 (Sun Chemical 249-1284); PALIOGEN Red 3340 (BASF); SUNFAST® Carbazole Violet 23 (Sun Chemical 246-1670); LITHOL Fast Scarlet L4300 (BASF); Sunbrite Yellow 17 (Sun Chemical 275-0023); HELIOGEN Blue L6900, L7020 (BASF); Sunbrite Yellow 74 (Sun Chemical 272-0558); SpectraPac® C Orange 16 (Sun Chemical 276-3016); HELIOGEN Blue K6902, K6910 (BASF); SUNFAST® Magenta 122 (Sun Chemical 228-0013); HELIOGEN Blue D6840, D7080 (BASF); Sudan Blue OS (BASF); NEOPEN Blue FF4012 (BASF); PV Fast Blue B2GO1 (Clariant); IRGALITE Blue BCA (Ciba); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991 K (BASF); PALIOTOL, Yellow 1840 (BASF); NOVOPERM Yellow FGL (Clariant); Lumogen Yellow D0790 (BASF); Suco-Yellow L1250 (BASF); Suco-Yellow D1355 (BASF); Suco Fast Yellow D1 355, D1 351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT), PALIOGEN Black L0084 (BASF); Pigment Black K801 (BASF); and carbon blacks such as REGAL 330™ (Cabot), Carbon Black 5250, Carbon Black 5750 (Columbia Chemical), mixtures thereof and the like.

Examples of suitable dyes include USHARECT Blue 86 (Direct Blue 86), available from Ushanti Color; INTRALITE Turquoise 8GL (Direct Blue 86), available from Classic Dyestuffs; CHEMICTIVE Brilliant Red 7BH (Reactive Red 4), available from Chemiequip; LEVAFIX Black EB, available from Bayer; REACTRON Red H8B (Reactive Red 31), available from Atlas Dye-Chem; D&C Red#28 (Acid Red 92), available from Warner-Jenkinson; Direct Brilliant Pink B, available from Global Colors; Acid Tartrazine, available from Metrochem Industries; CARTASOL Yellow 6GF Clariant; Carta Blue 2GL, available from Clariant; and the like. Example solvent dyes suitable for use herein may include NEOZAPON Red 492 (BASF); ORASOL Red G (Ciba); Direct Brilliant Pink B (Global Colors); AIZEN SPILON Red C-BH (Hodogaya Chemical); KAYANOL Red 3BL (Nippon Kayaku); Spirit Fast Yellow 3G; AIZEN SPILON Yellow C-GNH (Hodogaya Chemical); CARTASOL Brilliant Yellow 4GF (Clariant); PERGASOL Yellow CGP (Ciba); Orasol Black RLP (Ciba); SAVINYL Black RLS (Clariant); MORFAST Black Conc. A (Rohm and Haas); ORASOL Blue GN (Ciba); SAVINYL Blue GLS (Sandoz); LUXOL Fast Blue MBSN (Pylam); SEVRON Blue 5GMF (Classic Dyestuffs); BASACID Blue 750 (BASF), NEOZAPON Black X51 [C.I. Solvent Black, C.I. 12195] (BASF), Sudan Blue 670 [C.I. 61554] (BASF), Sudan Yellow 146 [C.I. 12700] (BASF), Sudan Red 462 [C.I. 260501] (BASF), mixtures thereof and the like.

The toners may contain from, for example, about 1% to about 25% by weight of the toner, on a dry basis, of the colorant. For example, the toners may contain colorant in an amount of from about 1% to about 15% by weight or from about 1% to about 12% by weight of the toner.

The toners may also include any additional additives, such as charge enhancing agents, emnbrittling agents, flow agents such as colloidal silica, and the like, as desired or necessary.

The toner particles may have, when no external additives are present on the toner particles, an average particle size of from about 1 to about 20 μm, such as from about 2 to about 15 μm or from about 3 to about 12 μm, as determined by use of a Coulter Counter or similar device.

The toner may be made by melt mixing the ingredients together in a mixing device. Examples of mixing devices are twin screw extruders, Banbury/rollmill, kneaders, and the like.

The toner particles may also be made by emulsion aggregation. Any suitable emulsion aggregation procedure may be used in forming the emulsion aggregation toner particles without restriction. These procedures typically include the basic process steps of at least aggregating an emulsion containing the binder, one or more colorants, optionally one or more surfactants, a wax, optionally a coagulant and one or more additional optional additives to form aggregates, subsequently coalescing or fusing the aggregates, and then recovering, optionally washing and optionally drying the obtained emulsion aggregation toner particles.

An example emulsion aggregation procedure may comprise providing a latex or emulsion of the binder components, the wax, any colorant, and any other desired or required additives. In embodiments, the pH of the pre-toner mixture is adjusted to between about 4 to about 5. The pH of the pre-toner mixture may be adjusted by an acid such as, for example, acetic acid, nitric acid or the like. Additionally, in embodiments, the pre-toner mixture optionally may be homogenized by mixing at about 600 to about 4,000 revolutions per minute. The particles may then be aggregated, for example through addition of an aggregating agent or coagulant to the emulsion. The aggregating agent is generally an aqueous solution of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. Aggregation may be accomplished at temperatures greater than about 60° C. During aggregation, additional material may be added to form a shell on an initially aggregated core particle. For example, a shell of binder only may be formed on the core. Following aggregation to the desired particle size, the aggregates may be coalesced. Coalescence may be accomplished by heating the aggregate mixture to a temperature that is about 5 to about 20° C. above the Tg of the binder. Generally, the aggregated mixture is heated to a temperature of about 50 to about 80° C. In embodiments, coalescence is accomplished by also stirring the mixture at a temperature of from about 200 to about 750 revolutions per minute. Optionally, during coalescence, the particle size of the toner particles may be controlled and adjusted to a desired size by adjusting the pH of the mixture. Generally, to control the particle size, the pH of the mixture is adjusted to between about 5 to about 7 using a base such as, for example, sodium hydroxide. After coalescence, the mixture is cooled to room temperature. After cooling, the mixture of toner particles is washed with water and then dried. Drying may be accomplished by any suitable method for drying including freeze drying.

The process may or may not include the use of surfactants. If used, the surfactants may be anionic, cationic or nonionic. Anionic surfactants include sodium dodecylsulfate (SDS), sodium dodecyl benzene sulfonate, sodium dodecylnaphthalene sulfate, dialkyl benzenealkyl, sulfates and sulfonates, abitic acid, and the NEOGEN brand of anionic surfactants available from Daiichi Kogyo Seiyaku Co. Ltd. Examples of cationic surfactants include dialkyl benzene alkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, and the like. Examples of nonionic surfactants include polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenc Inc. as IGEPAL CA-210, IGEPAL CA-520, IGEPAL CA-720, IGEPAL CO-890, IGEPAL CO-720, IGEPAL CO-290, IGEPAL CA-201, ANTAROX 890 and ANTAROX 897.

Following formation of the toner particles, external additives may be added to the toner particle surface by any suitable procedure such as those well known in the art. For example, suitable surface additives that may be used are one or more of SiO₂, metal oxides such as, for example, TiO₂ and aluminum oxide, and a lubricating agent such as, for example, a metal salt of a fatty acid (for example, zinc stearate (ZnSt), calcium stearate) or long chain alcohols such as UNILIN 700. SiO₂ and TiO₂ may be surface treated with compounds including DTMS (dodecyltrimethoxysilane) or HMDS (hexamethyldisilazane). Examples of these additives are NA50HS silica obtained from DeGussa/Nippon Aerosil Corporation, coated with a mixture of HMDS and aminopropyltriethoxysilane; DTMS silica, obtained from Cabot Corporation, comprised of a fumed silica, for example silicon dioxide core L90 coated with DTMS; H2050EP silica, obtained from Wacker Chemie, coated with an amino functionalized organopolysiloxane; TS530 from Cabot Corporation, Cab-O-Sil Division, a treated fumed silica; SMT5103 titania, obtained from Tayca Corporation, comprised of a crystalline titanium dioxide core MT500B, coated with DTMS; MT3103 titania, obtained from Tayca Corporation, comprised of a crystalline titanium dioxide core coated with DTMS. The titania may also be untreated, for example P-25 from Nippon Aerosil Co., Ltd. Zinc stearate may also be used as an external additive, the zinc stearate providing lubricating properties. Zinc stearate provides developer conductivity and tribo enhancement, both due to its lubricating nature. In addition, zinc stearate can enable higher toner charge and charge stability by increasing the number of contacts between toner and carrier particles. Calcium stearate and magnesium stearate provide similar functions. Most preferred is a commercially available zinc stearate known as ZINC STEARATE L, obtained from Ferro Corporation.

The toners may contain from, for example, about 0.1 to 5 weight percent titania, about 0.1 to 8 weight percent silica and about 0.1 to 4 weight percent zinc stearate.

The toners are sufficient for use in an electrostatographic or xerographic process. In this regard, the toner particles may be formulated into a developer composition by mixing with carrier particles. The toner concentration in each developer may ranges from, for example, about 1 to about 25%, such as from about 2 to about 15%, by weight of the total weight of the developer. Illustrative examples of carrier particles that can be selected for mixing with the toner include those particles that are capable of triboelectrically obtaining a charge of opposite polarity to that of the toner particles illustrative examples of suitable carrier particles include granular zircon, granular silicon, glass, steel, nickel, ferrites, iron ferrites, silicon dioxide, and the like. Additionally, there can be selected as carrier particles nickel berry carriers, comprised of nodular carrier beads of nickel, characterized by surfaces of reoccurring recesses and protrusions thereby providing particles with a relatively large external area. The carrier particles may be used with or without a coating, the coating generally being comprised of fluoropolymers, such as polyvinylidene fluoride resins, terpolymers of styrene, methyl methacrylate, a silane, such as triethoxy silane, tetrafluoroethylene, other known coatings and the like. The carrier core may be at least partially coated with a polymethyl methacrylate (PMMA) polymer.

In embodiments, any known type of image development system may be used in an image developing device, including, for example, magnetic brush development, jumping single-component development, hybrid scavengeless development (HSD), etc. These development systems are well known in the art, and further explanation of the operation of these devices to form an image is thus not necessary herein. The toners are included in a housing of the device, and provided from the housing to an image development station of the device in forming an image. Once the image is formed with toners/developers via a suitable image development method such as any one of the aforementioned methods, the image is then transferred to an image receiving medium such as paper and the like. The device may include a fuser roll member. Fuser roll members are contact fusing devices that are well known in the art, in which heat and pressure from the roll are used in order to fuse the toner to the image-receiving medium. Typically, the fuser member may be heated to a temperature just above the fusing temperature of the toner.

Toner compositions and processes for producing such toners according to the described embodiments are further illustrated by the following example.

### EXAMPLE

Toners of partially crosslinked bisphenol-A fumarate resin, 0%, 10%, or 20% crystalline polyester resin, 10% embrittling agent, 5% polypropylene wax, and 5% carbon black are melt mixed in a twin screw extruder. Each resulting toner is pulverized and size classified to an average of about 8.3 microns. External silicon oxide and titanium oxide additives are dry blended to enhance charge and flow performance. The resulting toners are then dry blended with a carrier. Fused prints were made using these toners in Xerox Nuvera® 120 machine. The prints were evaluated for crease and edge waviness, and the results of this testing are shown in FIGS. 1 and 2.

Although the invention has been described with reference to specific preferred embodiments, it is not intended to be limited thereto. Rather those having ordinary skill in the art will recognize that variations and modifications may be made therein which are within the spirit of the invention and within the scope of the claims.

What is claimed is:

1. A toner comprising a binder, at least one colorant and at least one wax, wherein the binder comprises an amorphous polyester material and a crystalline polyester material.

2. The toner according to claim 1, wherein the amorphous polyester material comprises a propoxylated bisphenol A fumarate.

3. The toner according to claim 1, wherein the binder further comprises a crosslinked polyester material.

4. The toner according to claim 3, wherein the crosslinked polyester material comprises a crosslinked propoxylated bisphenol A fumarate.

5. The toner according to claim 3, wherein the amorphous polyester material and the crosslinked polyester material are comprised of the same polyester.

6. The toner according to claim 5, wherein the crosslinked polyester material comprises crosslinked portions of the amorphous polyester material.

7. The toner according to claim 6, wherein the amorphous polyester material and the crosslinked polyester material are comprised of propoxylated bisphenol A fumarate, and wherein the binder has a gel content of from about 1% to about 50% by weight of the binder.

8. The toner according to claim 3, wherein the binder includes from about 25 to about 85 percent by weight of the toner of the amorphous polyester material and from about 3 to about 50 percent by weight of the toner of the crosslinked polyester material.

9. The toner according to claim 1, wherein the crystalline polyester material comprises a polyester derived from the reaction of an aliphatic diol and an aliphatic dicarboxylic acid.

10. The toner according to claim 1, wherein the crystalline polyester material comprises a polyester derived from the reaction of (a) 1,4-butanediol, 1,6-hexanediol, or mixtures thereof with (b) turmeric acid, oxalic acid, adipic acid, succinic acid, or mixtures thereof.

11. The toner according to claim 1, wherein the binder includes from about 3 to about 60 percent by weight of the toner of the crystalline polyester material.

12. The toner according to claim 1, wherein the at least one wax includes a polyethylene wax, a polypropylene wax, carnauba wax, or mixtures thereof.

13. A toner comprising a binder, at least one colorant and at least one wax, wherein the binder comprises an amorphous polyester material, a crosslinked polyester material, a crystalline polyester material, and wherein the toner has a glass transition temperature of from about 35° C. to about 60° C.

14. The toner according to claim 13, wherein toner particles of the toner have an average particle size of from about 1 to about 20 μm.

15. The toner according to claim 13, wherein the amorphous polyester material comprises a propoxylated bisphenol A fumarate.

16. The toner according to claim 15, wherein the crosslinked polyester material comprises a crosslinked propoxylated bisphenol A fumarate.

17. The toner according to claim 13, wherein the toner achieves a toned image on paper with a crease area value of about 60 or less at a fusing temperature of from about 60° C. to about 200° C.

18. The toner according to claim 13, wherein the toner achieves a toned image on paper with an edge waviness value of 3 or less at a fusing temperature of about 160° C. or less.

19. A developer comprising the toner according to claim 13 and a carrier.

20. A method of making a toner, comprising forming a mixture or emulsion containing at least a binder, at least one colorant and at least one wax, wherein the binder comprises an amorphous polyester material and a crystalline polyester material, and subsequently forming the toner from the mixture or emulsion.

21. The method according to claim 20, wherein the binder further comprises a crosslinked polyester material.
